(19) United States
(12) Patent Application Publication
(10) Pub. No.: US 2026/0124907 A1
(43) Pub. Date: May 7, 2026

(54) FAST FILL SYSTEM FOR REPLACEMENT FUEL TANK

(71) Applicant: SuperTanks LLC, Idaho Falls, ID (US)

(72) Inventors: James E. Patience, Idaho Falls, ID (US); Woodruff D. Smith, Idaho Falls, ID (US)

(21) Appl. No.: 19/375,324

(22) Filed: Oct. 31, 2025

Related U.S. Application Data
(60) Provisional application No. 63/716,095, filed on Nov. 4, 2024.

(51) Int. Cl. B60K 15/04; B60K 15/03

(52) U.S. Cl. CPC B60K 15/04; B60K 2015/03184; B60K 2015/03256; B60K 2015/03335; B60K 2015/0464; B60K 2015/0467

(57) ABSTRACT

A fast fill system is provided. The fast fill system includes first and second high flow roll-over valves, each coupled to flexible tubes. The system includes a replacement fuel tank with first and second inserts on top. The high flow roll-over valves couple to the replacement fuel tank through the respective inserts. The valves with flexible tubes allow the replacement fuel tank to expel up to 400% more air when refueling than without them. This enables filling by high-flow truck stop pumps at rates of 25+ gallons per minute without pressure buildup or spillage.

### CROSS-REFERENCE TO RELATED APPLICATION(S)

This application claims priority to U.S. Provisional Application No. 63/716,095, filed Nov. 4, 2024, the disclosure of which is hereby incorporated entirely herein by reference.

### TECHNICAL FIELD

The present disclosure relates to fuel tank systems, and more particularly to a fast fill system for replacement fuel tanks that enables high-flow refueling at truck stop pumps.

### STATE OF THE ART

Diesel-powered vehicles, particularly heavy-duty trucks and commercial vehicles, rely on fuel tank systems that can accommodate the demands of high-volume refueling operations. Modern truck stops and commercial fueling stations are equipped with high-flow fuel dispensing systems capable of delivering fuel at rates exceeding 25 gallons per minute. These high-flow systems enable rapid refueling of large-capacity fuel tanks, reducing downtime and improving operational efficiency for commercial vehicle operators.

Replacement fuel tanks for diesel vehicles present unique challenges in fuel system design. Unlike original equipment manufacturer tanks that are specifically engineered for particular vehicle applications, replacement tanks must accommodate various vehicle configurations while maintaining compatibility with existing fuel system components. The design of replacement tanks involves considerations such as tank capacity, mounting configurations, fuel pickup systems, and venting arrangements.

Fuel tank venting systems play a role in the refueling process by allowing air to escape from the tank as fuel enters. During high-flow refueling operations, the rate at which air must be expelled from the tank increases proportionally with the fuel flow rate. Conventional venting systems may become restrictive during high-flow refueling, potentially leading to pressure buildup within the tank, reduced fuel flow rates, or premature shut-off of the fuel dispensing nozzle.

The automotive aftermarket includes various replacement fuel tank options for diesel vehicles, with some tanks offering increased capacity compared to original equipment tanks. These larger capacity tanks, often referred to as extended range or XXL tanks, provide benefits such as increased driving range and reduced refueling frequency. However, the design of such tanks must address the challenges associated with proper venting during refueling operations, particularly when used with high-flow fuel dispensing systems.

Roll-over valves are commonly used in fuel tank systems to prevent fuel spillage in the event of vehicle rollover while also serving as venting components during normal operation. The design and sizing of these valves can influence the overall venting capacity of the fuel tank system and its compatibility with different refueling scenarios.

Accordingly, there is a need for an improved fast fill system for use with a replacement fuel tank.

### SUMMARY OF THE INVENTION

According to an aspect of the present disclosure, a fast fill system is provided. The fast fill system comprises a first high flow roll-over valve and a first flexible tube coupled to the first high flow roll-over valve. The system further comprises a second high flow roll-over valve and a second flexible tube coupled to the second high flow roll-over valve. The system includes a replacement fuel tank comprising a first insert and a second insert on a top of the replacement fuel tank. The first high flow roll-over valve is coupled to the replacement fuel tank through the first insert, and the second high flow roll-over valve is coupled to the replacement fuel tank through the second insert. The first and second high flow roll-over valves with the first and second flexible tubes are configured to allow the replacement fuel tank to expel up to 400% more air when refueling than without the first and second high flow roll-over valves.

According to another aspect of the present disclosure, a replacement fuel tank is provided. The replacement fuel tank comprises a tank body formed of high-density cross-linked polyethylene and a first insert and a second insert positioned on a top surface of the tank body.

The tank includes a first high flow roll-over valve coupled to the tank body through the first insert and a second high flow roll-over valve coupled to the tank body through the second insert. The tank further comprises a first flexible tube coupled to the first high flow roll-over valve and a second flexible tube coupled to the second high flow roll-over valve. The first and second high flow roll-over valves with the first and second flexible tubes enable the replacement fuel tank to be filled by high-flow truck stop pumps at rates of 25+ gallons per minute.

According to a further aspect of the present disclosure, a method of installing a fast fill system on a replacement fuel tank is provided. The method comprises the steps of removing a plug from a first insert on a top of the replacement fuel tank and removing a plug from a second insert on the top of the replacement fuel tank. The method includes setting up a system to catch plastic shavings, drilling a first hole in the first insert, and drilling a second hole in the second insert. The method further comprises trimming inside edges of the first and second holes and cleaning the replacement fuel tank of debris. The method includes threading a first high flow roll-over valve into the first hole and threading a second high flow roll-over valve into the second hole. The method concludes with coupling a first flexible tube to the first high flow roll-over valve and coupling a second flexible tube to the second high flow roll-over valve.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a side view of a fast fill system, according to an embodiment;

FIG. 2 is a partial section perspective view of the fast fill system of FIG. 1, according to an embodiment; and

FIG. 3 is a zoomed in partial section perspective view of the fast fill system of FIG. 1, according to an embodiment.

### DETAILED DESCRIPTION OF EMBODIMENTS OF THE INVENTION

As discussed above, embodiments of the present invention relate to a fast fill system for replacement fuel tanks that enables high-flow refueling at truck stop pump.

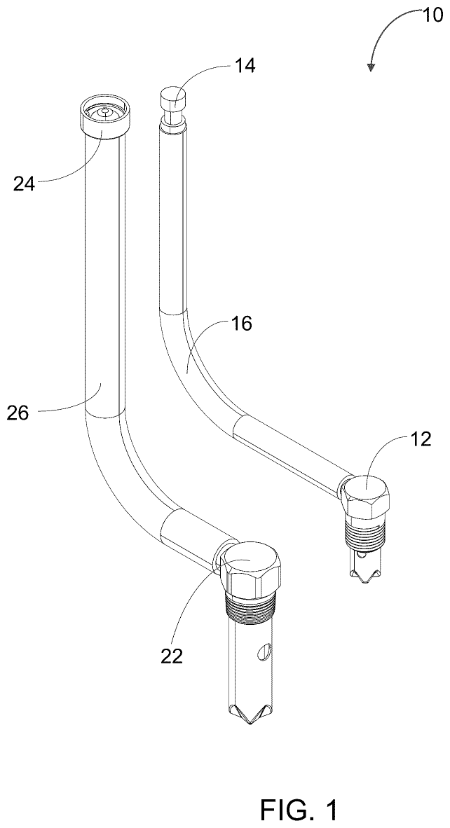

Referring to FIG. 1, a fast fill system 10 may be provided for enabling high-flow refueling operations. The fast fill system 10 may include a first high flow roll-over valve 12 and a second high flow roll-over valve 22 that work together to facilitate rapid fuel filling. A first flexible tube 16 may be coupled to the first high flow roll-over valve 12, while a second flexible tube 26 may be coupled to the second high flow roll-over valve 22. The first and second flexible tubes 16, 26 may extend outward from their respective roll-over valves 12, 22 to provide pathways for air expulsion during refueling operations.

As shown in FIG. 1, a first coupler 14 may be connected to an end of the first flexible tube 16, and a second coupler 24 may be connected to an end of the second flexible tube 26. The first coupler 14 and the second coupler 24 may be configured to be coupled together when the fast fill system 10 is not in use for refueling. This coupling arrangement may allow the system to be closed off when not actively dispensing fuel, while providing open pathways for air expulsion during refueling operations.

The first and second flexible tubes 16, 26 may be configured to allow air to be expelled therethrough during refueling operations. The first and second high flow roll-over valves 12, 22 with the first and second flexible tubes 16, 26 may be configured to allow a replacement fuel tank to expel up to 400% more air when refueling than without the first and second high flow roll-over valves 12, 22. This enhanced air expulsion capability may enable the replacement fuel tank to be filled at high pressure truck stop nozzles that pump fuel at rates of 25+ gallons per minute.

The fast fill system 10 may be designed for use with XXL replacement fuel tanks for diesel vehicles. The arrangement of components shown in FIG. 1 may enable smooth and rapid fill-up operations with no pressure buildup or spillage, allowing diesel vehicle operators to refuel faster and return to operation in reduced time.

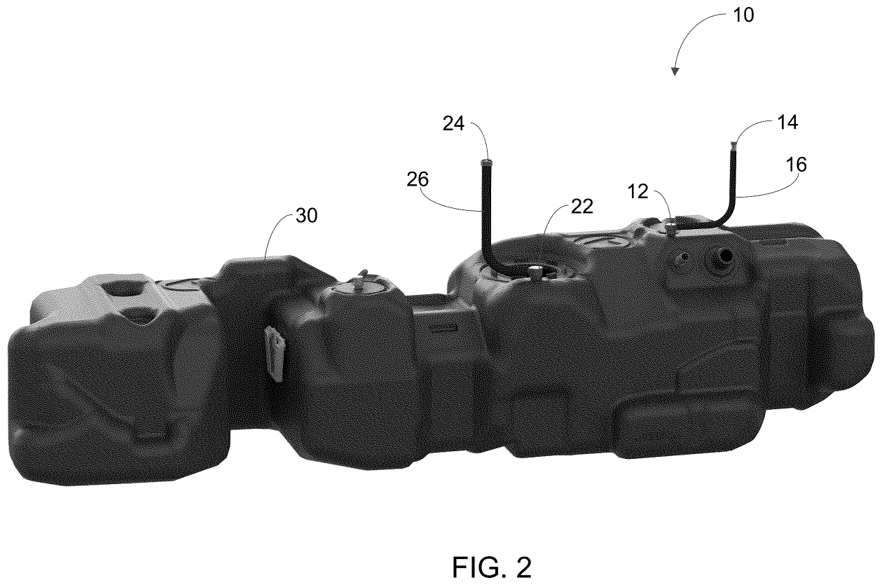

Referring to FIG. 2, the fast fill system 10 may be integrated with a replacement tank 30. The replacement tank 30 may comprise a tank body formed of high-density cross-linked polyethylene (XLHDPE) material. The high-density cross-linked polyethylene material may provide durability and chemical resistance for fuel storage applications.

The replacement tank 30 may include a first insert 32 and a second insert 34 positioned on a top surface of the tank body. The first insert 32 and the second insert 34 may be positioned above a fuel trap feature of the replacement tank 30. The fuel trap may be positioned below one of the inserts to facilitate fuel management within the replacement tank 30.

As shown in FIG. 2, the first high flow roll-over valve 12 may be coupled to the replacement tank 30 through the first insert 32. The second high flow roll-over valve 22 may be coupled to the replacement tank 30 through the second insert 34. The first and second high flow roll-over valves 12, 22 may be threaded into the first and second inserts 32, 34 respectively to provide secure mounting connections.

The first flexible tube 16 may be coupled to the first high flow roll-over valve 12, and the second flexible tube 26 may be coupled to the second high flow roll-over valve 22. The first coupler 14 may be connected to an end of the first flexible tube 16, and the second coupler 24 may be connected to an end of the second flexible tube 26. The first and second flexible tubes 16, 26 may be configured to allow air to be expelled therethrough during refueling operations.

The first and second high flow roll-over valves 12, 22 with the first and second flexible tubes 16, 26 may be configured to allow the replacement tank 30 to expel up to 400% more air when refueling than without the first and second high flow roll-over valves 12, 22. This enhanced air expulsion capability may enable the replacement fuel tank 30 to be filled by high-flow truck stop pumps at rates of 25+ gallons per minute without pressure buildup or spillage.

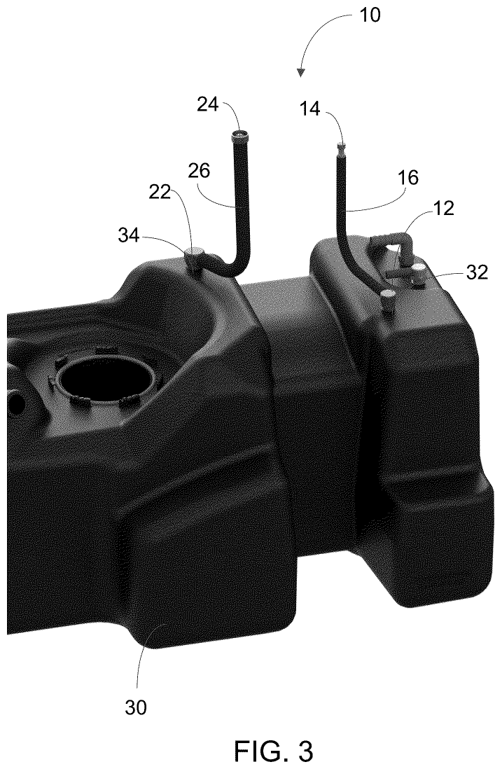

Referring to FIG. 3, a detailed view of the connection mechanism between the fast fill system 10 and the replacement tank 30 may be observed. The replacement tank 30 may include a first insert 32 and a second insert 34 positioned on the top surface of the replacement tank 30. The first insert 32 and the second insert 34 may provide threaded connection points for the roll-over valves.

As shown in FIG. 3, the first high flow roll-over valve 12 may be threaded into the first insert 32, creating a secure connection between the first high flow roll-over valve 12 and the replacement tank 30. Similarly, the second high flow roll-over valve 22 may be threaded into the second insert 34, establishing a connection pathway between the second high flow roll-over valve 22 and the replacement tank 30. The threaded connections may provide a leak-resistant seal while allowing for air expulsion during refueling operations.

With continued reference to FIG. 3, the first flexible tube 16 may couple to the first high flow roll-over valve 12, with the first coupler 14 positioned at an end of the first flexible tube 16. The first coupler 14 may provide a connection point that allows the first flexible tube 16 to be opened or closed as needed during refueling operations. In some cases, the second flexible tube 26 may couple to the second high flow roll-over valve 22, with the second coupler 24 positioned at an end of the second flexible tube 26.

As further shown in FIG. 3, the first coupler 14 and the second coupler 24 may be configured to be coupled together when the fast fill system 10 is not being used for refueling. This coupling configuration may close off the air expulsion pathway through the first flexible tube 16 and the second flexible tube 26 when refueling is not taking place. During refueling operations, the first coupler 14 and the second coupler 24 may be disconnected to allow air to be expelled through the first flexible tube 16 and the second flexible tube 26, preventing pressure buildup and spillage during high-flow refueling operations.

A method of installing a fast fill system on a replacement fuel tank may begin with removing a plug from a first insert on a top of the replacement fuel tank and removing a plug from a second insert on the top of the replacement fuel tank. These plugs or caps may be safely removed to allow access to the areas where drilling will occur.

The installation method may include setting up a system to catch plastic shavings to prevent debris from entering the tank and causing damage. In some cases, the step of setting up a system to catch plastic shavings may comprise placing a rag inside the replacement fuel tank beneath drilling locations. The system to catch plastic shavings may alternatively include using a vacuum with a hose directed at the drilling site to remove shavings during drilling operations. The rag or cloth may be positioned inside the tank to catch the shavings as they fall during the drilling process.

The method may proceed with drilling a first hole in the first insert and drilling a second hole in the second insert. The step of drilling the first hole and the step of drilling the second hole may each comprise starting with a pilot drill bit and gradually increasing drill bit size to achieve a desired hole diameter. This progressive drilling method may help prevent damage to the surrounding plastic material and may provide better control over the final hole size. The step of drilling may further comprise applying grease to the drill bit to catch plastic shavings. The grease on the drill bit may capture some of the plastic shavings and prevent them from falling into the tank during the drilling operations.

After drilling, the installation method may include trimming inside edges of the first and second holes. The trimming step may involve using a razor blade or utility knife to trim and smooth the inside edges of drilled holes. This trimming process may help ensure the holes are flush with any threads and may smooth out rough edges to provide a clean fit for the fittings.

The method may continue with cleaning the replacement fuel tank of debris. The step of cleaning the replacement fuel tank may comprise using compressed air to remove all plastic shavings and debris from inside the replacement fuel tank. The cleaning process may alternatively involve using a vacuum or a damp cloth to ensure the tank is completely free of debris. This cleaning step may prevent plastic pieces from entering the fuel system where they could cause damage or clog components.

Before installing the valves, the installation method may include applying thread seal tape to valve threads. Thread seal tape, such as Teflon tape, may be wrapped around the threads of the valves to provide a proper seal when the valves are installed.

The method may proceed with threading a first high flow roll-over valve into the first hole and threading a second high flow roll-over valve into the second hole. The valves may be carefully threaded into the drilled holes to avoid cross-threading and to ensure a secure connection to the replacement fuel tank.

The installation method may conclude with coupling a first flexible tube to the first high flow roll-over valve and coupling a second flexible tube to the second high flow roll-over valve. The flexible tubes may be connected to their respective roll-over valves to complete the fast fill system installation. In some cases, the method may further comprise connecting a first coupler to an end of the first flexible tube and connecting a second coupler to an end of the second flexible tube. These couplers may provide connection points for the flexible tubes and may allow the tubes to be coupled together when the fast fill system is not in use for refueling.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A fast fill system comprising:
a first high flow roll-over valve;
a first flexible tube coupled to the first high flow roll-over valve;
a second high flow roll-over valve;
a second flexible tube coupled to the second high flow roll-over valve;
a replacement fuel tank comprising a first insert and a second insert on a top of the replacement fuel tank, wherein:
the first high flow roll-over valve is coupled to the replacement fuel tank through the first insert;
the second high flow roll-over valve is coupled to the replacement fuel tank through the second insert; and
the first and second high flow roll-over valves with the first and second flexible tubes are configured to allow the replacement fuel tank to expel up to 400% more air when refueling than without the first and second high flow roll-over valves.

2. The fast fill system of claim 1, further comprising a first coupler connected to an end of the first flexible tube and a second coupler connected to an end of the second flexible tube.

3. The fast fill system of claim 2, wherein the first coupler and the second coupler are configured to be coupled together when the fast fill system is not in use for refueling.

4. The fast fill system of claim 1, wherein the first and second flexible tubes are configured to allow air to be expelled therethrough during refueling operations.

5. The fast fill system of claim 1, wherein the replacement fuel tank is configured to be filled at high pressure truck stop nozzles that pump fuel at 25+ gallons per minute.

6. The fast fill system of claim 1, wherein the first and second inserts are positioned on a top surface of the replacement fuel tank.

7. The fast fill system of claim 6, wherein the first and second high flow roll-over valves are threaded into the first and second inserts respectively.

8. A replacement fuel tank comprising:
a tank body formed of high-density cross-linked polyethylene;
a first insert and a second insert positioned on a top surface of the tank body;
a first high flow roll-over valve coupled to the tank body through the first insert;
a second high flow roll-over valve coupled to the tank body through the second insert;
a first flexible tube coupled to the first high flow roll-over valve; and
a second flexible tube coupled to the second high flow roll-over valve, wherein the first and second high flow roll-over valves with the first and second flexible tubes enable the replacement fuel tank to be filled by high-flow truck stop pumps at rates of 25+ gallons per minute.

9. The replacement fuel tank of claim 8, further comprising a first coupler connected to an end of the first flexible tube and a second coupler connected to an end of the second flexible tube.

10. The replacement fuel tank of claim 9, wherein the first coupler and the second coupler are configured to be coupled together when the replacement fuel tank is not being refueled.

11. The replacement fuel tank of claim 8, wherein the first and second flexible tubes are configured to allow air to be expelled therethrough during refueling operations.

12. The replacement fuel tank of claim 8, wherein the first and second high flow roll-over valves are threaded into the first and second inserts respectively.

13. The replacement fuel tank of claim 8, wherein the first and second high flow roll-over valves with the first and second flexible tubes are configured to allow the replacement fuel tank to expel up to 400% more air when refueling than without the first and second high flow roll-over valves.

14. The replacement fuel tank of claim 13, wherein the replacement fuel tank is configured to prevent pressure buildup and spillage during high-flow refueling operations.

15. A method of installing a fast fill system on a replacement fuel tank, comprising the steps of:
removing a plug from a first insert on a top of the replacement fuel tank;
removing a plug from a second insert on the top of the replacement fuel tank;
setting up a system to catch plastic shavings;
drilling a first hole in the first insert;
drilling a second hole in the second insert;
trimming inside edges of the first and second holes;
cleaning the replacement fuel tank of debris;
threading a first high flow roll-over valve into the first hole;
threading a second high flow roll-over valve into the second hole;
coupling a first flexible tube to the first high flow roll-over valve; and
coupling a second flexible tube to the second high flow roll-over valve.

16. The method of claim 15, wherein the step of setting up a system to catch plastic shavings comprises placing a rag inside the replacement fuel tank beneath drilling locations.

17. The method of claim 15, wherein the step of drilling the first hole and the step of drilling the second hole each comprise starting with a pilot drill bit and gradually increasing drill bit size to achieve a desired hole diameter.

18. The method of claim 17, wherein the step of drilling further comprises applying grease to the drill bit to catch plastic shavings.

19. The method of claim 15, further comprising the steps of connecting a first coupler to an end of the first flexible tube and connecting a second coupler to an end of the second flexible tube.

20. The method of claim 15, wherein the step of cleaning the replacement fuel tank comprises using compressed air to remove all plastic shavings and debris from inside the replacement fuel tank.
